(19) United States
(12) Patent Application Publication
(10) Pub. No.: US 2005/0208953 A1
(43) Pub. Date: Sep. 22, 2005

(54) System and method for providing poisition information of mobile terminal using cellular broadcasting technology

(76) Inventor: Hong Woo Lee, Seoul (KR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/851,078

(22) Filed: May 24, 2004

(30) Foreign Application Priority Data
Mar. 16, 2004 (KR) 2004-17750

(51) Int. Cl. H04B 7/185

(52) U.S. Cl. 455/456.1

(57) ABSTRACT

There are provided a system and a method for providing position information of a mobile terminal using cellular broadcasting technology. The ephemeris and almanac information of the GPS satellite required for calculating the position of the mobile terminal are broadcasted by the CBS through the BTS to which the mobile terminal is pertinent, so that the call processing procedure between the mobile terminal and the PDE which is usually carried out to obtain the position information of the GPS satellite may be omitted. In the case that the position of the mobile terminal is changed in real time by a vehicle or the like, it can provide very precisely the position information of the mobile terminal since the time consumed for the mobile terminal to define the traffic channel for obtaining the position information of the GPS satellite is reduced. In addition, in the system of the present invention, since the call processing procedure is simplified, a load applied to the PDE is reduced, so that it can suppress the additional installation of the PDE which is an expensive device relative to other components.

### BACKGROUND OF THE INVENTION

1. Field of the Invention

The present invention relates to a system and a method for providing position information of a mobile terminal using cellular broadcasting technology, and more particularly, to a system and a method for receiving position information from a satellite of GPS, broadcasting the information in a unit of cell such that the mobile terminal in a pertinent cell may calculate position information thereof and provide the information to the system.

2. Description of the Related Art

Due to development of mobile communication technology, it has been proposed a mobile communication network having a function of tracing a position of a mobile terminal using position information transmitted from a satellite of Global Positioning System (GPS). The satellite of GPS transmits almanac information indicative of its own position and ephemeris information indicative of more precise position of the satellite of pertinent GPS. An earth station for satellite communication receives the almanac information and the ephemeris information and sends them to a mobile communication network. The almanac information and the ephemeris information are referred to as position information of the satellite of GPS. The mobile communication network calculates the position information of the mobile terminal using the position information of the satellite of GPS.

FIG. 1 is a schematic view illustrating a construction of a conventional system for providing position information of a mobile terminal.

Referring to FIG. 1, a conventional mobile communication network generally includes a base station transceiver subsystem (BTS) 21, a base station controller (BSC) 22, and a PCS central exchange (PCX) 23. A mobile positioning center (MPC) 24 and a position determination entity (PDE) 25 which integrally manage the position information of the mobile terminal support a function of providing the position information of a mobile terminal 10 in the mobile communication network. An application service provider (ASP) 26 is connected to the mobile communication network to provide supplementary services.

Each of the BTSs 21 is allocated to one cell of a desired dimension, and a predetermined number of BTSs are connected to the BSC 22. A predetermined number of BSCs 22 are connected to the PCX 23 to provide a communication function of the mobile terminal. On the other hand, the PCX 23 are connected to the MPC 24, the PDE 25 and the ASP 26 in turn. The PDE 25 is connected to an earth station 27 for satellite communication to receive the position information of the satellite 30 of GPS.

The conventional system configured as described above will now be described with reference to FIG. 2 depicting a call processing procedure.

The mobile terminal 10 is connected to the mobile communication network via TCP/IP or a data burst message (DBM) to define a traffic channel, and notifies the PDE 25 of the information of the BTS 21, to which the current mobile terminal is pertinent, via the mobile communication network, as well as pilot phase measurements. At the same time, the mobile terminal 10 requests the PDE 25 for location response, almanac information and ephemeris information (step S1). The location response is approximately current position data (latitude and longitude) of the mobile terminal 10 which is calculated by the PED 25 on the basis of the BTS 21. The BTS 25 determines a satellite of GPS to be effectively used at the position of the current mobile terminal 10 based on the information of the mobile terminal and the pilot phase measures transmitted via the mobile communication network and the MPC 24, receives the determined position information (almanac and ephemeris) of the satellite of GPS from the earth station 27 for the satellite communication 27, and transmits the position information and the location response to the pertinent mobile terminal 10 via the MPC 24 and the mobile communication network (step S2). The mobile terminal 10 conducts a search for the pertinent satellite of GPS using the location response transmitted from the PDE 25 and the position information of the satellite of GPS, so as to measure a phase difference between the terminal and the satellite of GPS and then calculate its own location. The mobile terminal 10 obtains its own position information, and sets an operation end flag as “1”. Status information of the mobile terminal is transmitted to the PDE 25 via the mobile communication network and the MPC 24 (step S3).

The conventional system configured as described above has a disadvantage of prolonging a call processing time due to the complicated call processing procedure. Specifically, when the position tracing function is performed, the mobile terminal executes application service to define the traffic channel with a position determination device. Also, the mobile terminal provides the information of the terminal (information of the earth station to which the mobile terminal is pertinent) and the pilot phase measures, and simultaneously, requests the PDE for the location response, the ephemeris information and the almanac information. A considerable time is consumed so that the mobile terminal defines the traffic channel with the PDE. In the case where the mobile terminal is moving at that point, an error is caused in the position measurement of the mobile terminal. The PDE should maintain a session with the mobile terminal to provide the position tracing function. As such, if the call processing procedure between the mobile terminal and the PDE is complicated, an excessive load is applied to the PDE, so that an expensive server is additionally required.

### SUMMARY OF THE INVENTION

Accordingly, the present invention is directed to a system and a method for providing position information of a mobile terminal using cellular broadcasting technology that substantially obviates one or more problems due to limitations and disadvantages of the prior art.

It is an object of the present invention to provide a system and a method for broadcasting information in the unit of cell such that a mobile terminal in a pertinent cell may calculate position information thereof and provide the information to the system, thereby simplifying a call processing procedure between the mobile terminal and a position determination entity and providing real-time position information of the mobile terminal.

To achieve these objects and other advantages and in accordance with the purpose of the invention, as embodied and broadly described herein, there is provided a system for providing position information of a mobile terminal using cellular broadcasting technology, and the system includes a mobile communication network including a plurality of base station transceiver subsystems each installed in one cell in a desired service area divided in a unit of cell and transmitting a signal for defining call setting with the mobile terminal in a pertinent cell, a base station controller installed in the unit of at least one base station transceiver subsystem for controlling a function of the pertinent base station transceiver subsystem, and a PCS central exchange installed in the unit of at least one base station controller, and defining and maintaining the traffic channel; a cellular broadcasting system for broadcasting position information of a GPS satellite via the mobile communication network in the unit of cell, the broadcasting being serviced by each base station transceiver subsystem of the mobile communication network; a mobile positioning center for transmitting a signal required to trace the position of the mobile terminal and transmitting the position information of the GPS satellite to the cellular broadcasting system; and a position determination entity for classifying the position information consisting of ephemeris and almanac information received from the GPS satellite in the unit of cell serviced by each base station transceiver subsystem of the mobile communication network to provide the mobile positioning center with the position information.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating a construction of a conventional system for providing position information of a mobile terminal;

FIG. 2 shows a call processing procedure applied to the system of FIG. 1;

FIG. 3 is a schematic view illustrating a construction of a system for providing position information of a mobile terminal using cellular broadcasting technology according to one preferred embodiment of the present invention; and

FIG. 4 shows a call processing procedure applied to the system of FIG. 3.

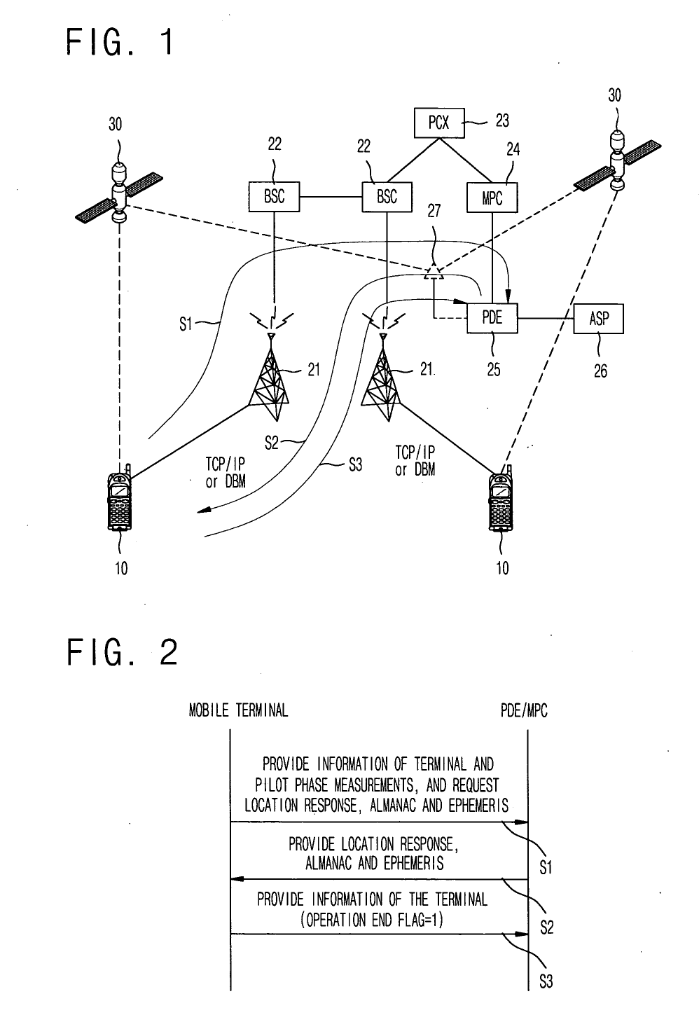

### DETAILED DESCRIPTION OF THE PREFERRED EMBODIMENT

Reference will now be made in detail to the preferred embodiment of the present invention, an example of which is illustrated in the accompanying drawings.

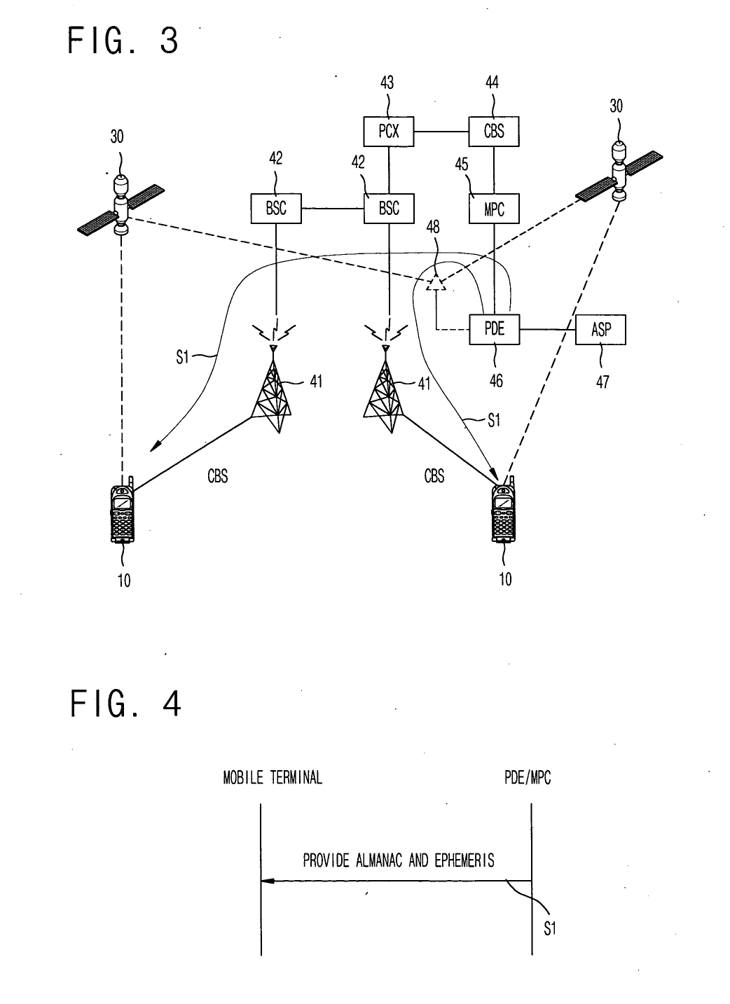

FIG. 3 is a schematic view illustrating a construction of a system for providing position information of a mobile terminal using cellular broadcasting technology according to one preferred embodiment of the present invention, and FIG. 4 shows a call processing procedure applied to the system of FIG. 3.

As shown in FIG. 3, the system according to one preferred embodiment of the present invention includes a mobile communication network for defining a traffic channel with a mobile terminal, a cellular broadcasting system (CBS) 44 for broadcasting position information of a satellite of GPS via the mobile communication network in the unit of cell, the broadcasting being serviced by each base station of the mobile communication network, a mobile positioning center (MPC) 45 for transmitting a signal required to trace the position of the mobile terminal and also transmitting the position information of the GPS satellite to the cellular broadcasting system, and a position determination entity (PDE) 46 for classifying the position information consisting of ephemeris and almanac information of the GPS satellite in the unit of cell serviced by each base station of the mobile communication network to provide the MPC with the position information.

The mobile communication network includes a plurality of base station transceiver subsystems (BTSs) 41 each installed in one cell in a desired service area divided in the unit of cell and transmitting a signal for defining call setting with the mobile terminal in the pertinent cell, a base station controller (BSC) 42 installed in the unit of at least one BTS for controlling a function of the pertinent BTS, and a PCS central exchange (PCX) 43 installed in the unit of at least one BSC 42 and defining and maintaining the traffic channel.

The PDE 46 is connected to an earth station 48 for satellite communication to receive the position information consisting of ephemeris and almanac information of each GPS satellite from a plurality of GPS satellites 30. Also, the PDE 46 is connected to an application service provider (ASP) 47 to provide the mobile terminal 10 with supplementary application services related to the position trace. The mobile terminal 10 sets the traffic channel in a usable state to receive the position information (ephemeris and almanac) of the GPS satellite via a CBS message.

The PDE 46 receives the position information containing ephemeris and almanac of the GPS satellite 30 which is received by the earth station 48 for satellite communication. The transmitted ephemeris and almanac information of the GPS satellite are classified in the unit of cell of the mobile communication network. The GPS satellites effectively available in each cell of the mobile communication network are different every cell. Therefore, the position information of the GPS satellite required in each cell is different to each other. In the system according to the embodiment of the present invention, the information related to the GPS satellite usable in each cell is predetermined in the PDE 46. The PDE 46 classifies the position information of the GPS satellite in the unit of cell by using the predetermined information. The position information of the GPS satellite transmitted from the PDE 46 is sent to the CBS 44 via the MPC 45. The CBS 44 broadcasts the position information of the GPS satellite transmitted in the unit of cell of the mobile communication network at a desired period of time, for example a period of 30 minutes to 2 hours. Each BTS of the mobile communication network transmits the broadcasted position information of the GPS satellite to each mobile terminal 30 placed in the cell area serviced by the current BTS. Accordingly, it is possible for the mobile terminal 10 to receive the position information of the GPS satellite to be effectively utilized in the location of interest from the BTS 41 servicing the cell where the terminal is placed. Then, the mobile terminal 10 conducts a search for the GPS satellite using the received the position information of the GPS satellite, and calculates its own location using pseudorange data between the GPS satellite and the mobile terminal.

On the other hand, according to the system of the present invention, the CBS 44 broadcasts the position information of the GPS satellite to a mobile terminal 10 in a pertinent cell in the unit of a desired time through each BTS 41 of the mobile communication network. If a power of the mobile terminal 10 is switched from OFF to ON, the respective mobile terminals 10 does not receive the position information of the GPS satellite through the CBS 44 until the broadcasting period is achieved. Accordingly, at the initial power ON of the mobile terminal 10, the mobile terminal 10 should request the position information of the GPS satellite separately. Thus, at the initial power ON of the mobile terminal 10, the mobile terminal 10 requests the position information of the GPS satellite, according to a process shown in FIG. 2, and calculates its own position using the response to the request.

With above description of the system and the method of the present invention, the ephemeris and almanac information of the GPS satellite required for calculating the position of the mobile terminal are broadcasted by the CBS through the BTS to which the mobile terminal is pertinent, so that the call processing procedure between the mobile terminal and the PDE, which is usually carried out to obtain the position information of the GPS satellite, may be omitted. The system and the method of the present invention can save about 10 seconds needed for the mobile terminal to define the traffic channel in order to obtain the position information of the GPS satellite. The call processing procedure is simplified in relation to the conventional system, thereby additionally reducing about 1 or 2 seconds. Accordingly, the system and the method of the present invention can save about 12 seconds in relation to the conventional system. In the case that the position of the mobile terminal is changed in real time by a vehicle or the like, it can provide very precisely the position information of the mobile terminal.

In addition, in the system of the present invention, since the call processing procedure is simplified, a load applied to the PDE is reduced, so that it can suppress the additional installation of the PDE which is an expensive device relative to other components.

The foregoing embodiment is merely exemplary and is not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

1. A system for providing position information of a mobile terminal using cellular broadcasting technology, the system comprising:
a mobile communication network including a plurality of base station transceiver subsystems each installed in one cell in a desired service area divided in a unit of cell and transmitting a signal for defining call setting with the mobile terminal in a pertinent cell, a base station controller installed in the unit of at least one base station transceiver subsystem for controlling a function of the pertinent base station transceiver subsystem, and a PCS central exchange installed in the unit of at least one base station controller, and defining and maintaining the traffic channel;
a cellular broadcasting system for broadcasting position information of a GPS satellite via the mobile communication network in the unit of cell, the broadcasting being serviced by each base station transceiver subsystem of the mobile communication network;
a mobile positioning center for transmitting a signal required to trace the position of the mobile terminal and transmitting the position information of the GPS satellite to the cellular broadcasting system; and
a position determination entity for classifying the position information consisting of ephemeris and almanac information received from the GPS satellite in the unit of cell serviced by each base station transceiver subsystem of the mobile communication network to provide the mobile positioning center with the position information.

2. The system as claimed in claim 1, wherein the position determination entity is connected to an earth station for satellite communication to receive the position information consisting of the ephemeris and almanac information of each GPS satellite from the earth station.

3. The system as claimed in claim 1, wherein the position determination entity is connected to an application service provider to provide the mobile terminal with supplementary application services related to the position trace.

4. The system as claimed in claim 1, wherein the information related to the GPS satellite usable in each cell of the mobile communication network is predetermined in the position determination entity, and the position determination entity classifies the position information of the GPS satellite in the unit of cell by using the predetermined information.

5. The system as claimed in claim 1, wherein the mobile terminal receives the position information of the GPS satellite to be effectively utilized in the location of interest from the base station transceiver subsystem servicing the cell in which the terminal is placed, and the mobile terminal conducts a search for the GPS satellite using the received position information of the GPS satellite, and calculates its own location using pseudorange data between the searched GPS satellite and the mobile terminal.
